(19) United States
(12) Patent Application Publication
(10) Pub. No.: US 2013/0099154 A1
(43) Pub. Date: Apr. 25, 2013

(54) COMPOSITIONS OF TETRAFLUOROPENE AND POLYOL ESTER LUBRICANTS

(71) Applicants: Beatrice Boussand, Sainte Foy Les Lyon (FR); Brett L. Van Horn, King of Prussia, PA (US)

(72) Inventors: Beatrice Boussand, Sainte Foy Les Lyon (FR); Brett L. Van Horn, King of Prussia, PA (US)

(21) Appl. No.: 13/807,329

(22) PCT Filed: Jun. 30, 2011
(86) PCT No.: PCT/US11/42520

§ 371 Date: Dec. 28, 2012

Related U.S. Application Data
(60) Provisional application No. 61/361,635, filed on Jul. 6, 2010.

(51) Int. Cl. C09K 5/00

(52) U.S. Cl. CPC C09K 5/00
USPC 252/68

(57) ABSTRACT

The present invention relates to heat transfer fluid combinations for use in refrigeration, heat transfer, heat pump, and air conditioning applications. More particularly, the present invention relates to heat transfer fluid combinations of 1,3,3,3-tetrafluoropropene and polyol ester (POE) oils which are useful in refrigeration, heat transfer, heat pump, and air conditioning systems.

### FIELD OF THE INVENTION

The present invention relates to heat transfer fluids comprising 1,3,3,3-tetrafluoropropene and polyol ester (POE) oils. The formulations of the present invention are particularly useful compositions for use in refrigeration, heat transfer, heat pump, and air conditioning systems.

### BACKGROUND OF THE INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbons (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications. Though they are deemed “friendly” to the ozone layer they still generally possess high global warming potentials. One class of compounds that has been identified to replace ozone depleting or high global warming substances are hydrofluoroolefins (HFOs). An important consideration when developing new refrigerants or refrigerating systems is material compatibility and stability, particularly of the refrigerant and lubricant. A high degree of stability helps maintain the service life of the system and optimal performance; low stability can result in the formation of corrosive degradation products, sediments, tars, or other by-products that damage equipment, degrade system performance, are toxic, etc.

In the present invention, it was discovered that combinations of 1,3,3,3-tetrafluoropropene (HFO-1234ze) with polyol ester (POE) lubricating oils have suprisingly good stability.

### SUMMARY OF THE INVENTION

The present invention relates to heat transfer fluids comprising 1,3,3,3-tetrafluoropropene and polyol ester (POE) oils. The formulations of the present invention are particularly useful compositions for use in refrigeration, heat transfer, heat pump, and air conditioning applications.

### DETAILED DESCRIPTION OF THE INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbons (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications. Though they are deemed “friendly” to the ozone layer they still generally possess high global warming potentials. One class of compounds that has been identified to replace ozone depleting or high global warming substances are hydrofluoroolefins (HFOs).

A good understanding of the chemical interactions of the refrigerant, lubricant, and metals in a refrigeration system is necessary for designing systems that are reliable and have a long service life. Incompatibility between the refrigerant and other components of or within a refrigeration or heat transfer system can lead to decomposition of the refrigerant, lubricant, and/or other components, the formation of undesirable byproducts, corrosion or degradation of mechanical parts, loss of efficiency, or a general shortening of the service life of the equipment, refrigerant and/or lubricant.

In the present invention, it was discovered that combinations of 1,3,3,3-tetrafluoropropene (HFO-1234ze), preferably the trans-isomer, with polyol ester lubricating oils are unexpectedly stable, and can therefore be particularly useful as heat transfer fluids for use in refrigeration, heat transfer, heat pump, or air conditioning systems while providing both the benefits of an extended service life as well as greater environmental sustainability.

In a refrigeration, heat transfer, heat pump, or air conditioning system, lubricating oil and refrigerant are expected to be in contact with each other in at least some parts of the system, if not most of the system, as explained in the ASHRAE Handbook: HVAC Systems and Equipment. Therefore, whether the lubricant and refrigerant are added separately or as part of a pre-mixed package to a refrigeration, air conditioning, or heat transfer system, they are still expected to be in contact within the system and must therefore be compatible.

The stability of combinations of refrigerant and lubricant can be evaluated in terms of thermal stability, chemical stability, oxidative stability, and hydrolytic stability. Copper plating is also a measure of compatibility of refrigerant and lubricant mixtures. The stability of refrigerant and lubricant mixures can be affected by the content of air or oxygen, water, metals, or other impurities. In one embodiment of the present invention, the heat transfer fluids preferably have a low moisture content, more preferably where the water content is less than about 1000 ppm, even more preferably where the water content is less than about 500 ppm, even more preferably where the water content is less than about 300 ppm, even more preferably where the water content is less than about 100 ppm, and even more preferably where the water content is less than about 50 ppm. In one embodiment of the present invention, the heat transfer fluids preferably have a low content of air or oxygen. In one embodiment of the present invention, the heat transfer fluids preferably have a low metals and/or metal ion content.

The following is an exemplary description of polyol ester (POE) lubricating oils and is not meant to limit the scope of the present invention in any way. POE oils are typically formed by a chemical reaction (esterification) of a carboxylic acid, or mixture of carboxylic acids, with an alcohol, or mixtures of alcohols. Water formed during this reaction is eliminated to avoid the reverse reaction (i.e. hydrolysis). The carboxylic acids are typically mono-functional or di-functional. The alcohols can be mono-functional or poly-functional. Polyols contain at least 2 hydroxyl groups. The carboxylic acids are typically poly-functional. The polyols are typically di-, tri-, or tetra-functional. Examples of polyols include, but are not limited to, neopentylglycol, glycerin, trimethylolpropane, pentaerythritol, and mixtures thereof. Examples of carboxylics acids include, but are not limited to, ethyl hexanoic acid, including 2-ethyl hexanoic acid, trimethyl hexanoic acid, including 3,5,5-trimethyl hexanoic acid, octanoic acid, including linear octanoic acid, pentanoic acid, including n-pentanoic acid, neo acids, including dimethylpentanoic acid, C5 to C20 carboxylic acids, and mixtures thereof. The carboxylic acids may also be derived from natural sources, including, but not limited to, plant and vegatable oils of soybean, palm, olive, rapeseed, cottonseed, coconut, palm kernal, corn, castor, sesame, jojoba, peanut, sunflower, others, and mixtures thereof Natural oil carboxylic acids are typically C18 acids but also include C12-C20 acids, among others. In one embodiment of the present invention, the POE oil is formulated using one or more mono-functional carboxylic acids with one or more polyols. In one embodiment of the present invention, the POE oil is formulated using one or more di-functional carboxylic acids with one or more mono-functional alcohols. In one embodiment of the present invention, the POE oil is a mixture of different POE oils. In one embodiment of the present invention, the POE oil is formulated using one or more C5-C10 carboxylic acids.

In a preferred embodiment of the present invention, the polyols are preferably those having a neopentyl backbone, preferably neopentyl glycol, trimethylol propane, pentaerythritol, dipentaerythritol, and mixtures thereof; most preferably pentaerythritol.

In a preferred embodiment of the present invention, the carboxylic acids preferably contain 2 to 15 carbons; the carbon backbone is preferably linear or branched. Examples of carboxylics acids include, but are not limited to, n-pentanoic acid, n-hexanoic acid, n-heptanoic acid, n-octanoic acid, 2-ethylhexanoic acid, 2,2-dimethylpentanoic acid, 3,5,5-trimethylhexanoic acid, adipic acid, succinic acid, and mixtures thereof.

Some alcohol functions may not be esterified, though the quantity of which is typically small. Thus, the POE may include between 0 and 5% by mole of CH2—OH relative to —CH2—O—(C═O)—.

In one embodiment of the present invention, the lubricants are those having a viscosity of 1 to 1000 centistokes (cSt) at 40° C., preferably 10 to 200 cSt, and more preferably 30 to 80 eSt.

The heat transfer fluids of the present invention, comprising 1,3,3,3-tetrafluoropropene, preferrably trans-1,3,3,3-tetrafluoropropene, and polyol ester (POE) lubricating oils, are intended for use in refrigeration, heat transfer, heat pump, and air conditioning systems including use in new systems, servicing of exisitng systems, and retrofitting of existing systems.

The tetrafluoropropene of the present invention is 1,3,3,3-tetrafluoropropene (HFO-1234ze). As used herein, 1,3,3,3-tetrafluoropropene refers to the trans-isomer, the cis-isomer, and/or mixtures thereof. In the present invention, the 1,3,3,3-tetrafluoropropene is preferably the trans-isomer. In an embodiment of the present invention the 1,3,3,3-tetrafluoropropene is essentially the trans-isomer.

The heat transfer fluids of the present invention can also be used with other refrigerants such as hydrofluorocarbons, hydrochlorofluorocarbons, hydrofluoroolefins, hydrochlorofluoroolefins, hydrocarbons, hydrofluoroethers, fluoroketones, chlorofluorocarbons, trans-1,2-dichloroethylene, carbon dioxide, dimethyl ether, ammonia, and mixtures thereof. Exemplary hydrofluorocarbons include difluoromethane (HFC-32); 1-fluoroethane (HFC-161); 1,1-difluoroethane (HFC-152a); 1,2-difluoroethane (HFC-152); 1,1,1-trifluoroethane (HFC-143a); 1,1,2-trifluoroethane (HFC-143); 1,1,1,2-tetrafluoroethane (HFC-134a); 1,1,2,2-tetrafluoroethane (HFC-134); 1,1,1,2,2-pentafluoroethane (HFC-125); 1,1,1,3,3-pentafluoropropane (HFC-245fa); 1,1,2,2,3-pentafluoropropane (HFC-245ca); 1,1,1,2,3-pentafluoropropane (HFC-245eb); 1,1,1,3,3,3-hexafluoropropane (HFC-236fa); 1,1,1,2,3,3,3-heptafluoropropane (HFC-227ea); 1,1,1,3,3-pentafluorobutane (HFC-365mfe), 1,1,1,2,3,4,4,5,5,5-decafluoropropane (HFC-4310), and mixtures thereof. Exemplary chlorofluorocarbons include trichlorofluoromethane (R-11), dichlorodifluoromethane (R-12), 1,1,2-trifluoro-1,2,2-trifluoroethane (R-113), 1,2-dichloro-1,1,2,2-tetrafluoroethane (R-114), chloro-pentafluoroethane (R-115) and mixtures thereof. Exemplary hydrocarbons include propane, butane, isobutane, n-pentane, iso-pentane, neo-pentane, cyclopentane, and mixtures thereof. Exemplary hydrofluoroolefins include 3,3,3-trifluorpropene (HFO-1234zf), 2,3,3,3-tetrafluoropropene (HFO-1234yf, E-1,2,3,3,-pentafluoropropene (E-HFO-1225ye), Z-1,2,3,3,3-pentafluoropropene (Z-HFO-1225ye), E-1,1,1,3,3,3-hexafluorobut-2-ene (E-HFO-1336mzz), Z-1,1,1,3,3,3-hexafluorobut-2-ene (Z-HFO-1336mzz), 1,1,1,4,4,5,5,5-octafluoropent-2-ene (HFO-1438mzz) and mixtures thereof. Exemplary hydrochlorofluoroolefins include E-1-chloro-3,3,3-trifluoropropene (E-HCFO-1233zd), Z-1-chloro-3,3,3-trifluoropropene (Z-HCFO-1233zd), 2-chloro-3,3,3-trifluoropropene (HCFO-1233xf). Exemplary hydrofluoroethers include 1,1,1,2,2,3,3-heptafluoro-3-methoxy-propane, 1,1,1,2,2,3,3,4,4-nonafluoro-4-methoxy-butane and mixtures thereof. An exemplary fluoroketone is 1,1,1,2,2,4,5,5,5-nonafluoro-4(trifluoromethyl)-3-3pentanone.

The heat transfer fluids of the present invention can also include lubricants in addition to the POE lubricants. Preferably the weight ratio of polyol ester lubricating oil to additional lubricants is greater than about 1:1, preferably greater than about 2:1, and even more preferably greater than about 4:1. Examples additional lubricants include mineral oils, alkylbenzenes, polyalkylene glycols (PAG), polyvinyl ethers (PVE), polyglycols, polyalkylene glycol ethers, polyalphaolefins, and mixtures thereof Preferably, the lubricant does not contain PAG. PAG oils can be ‘un-capped’, ‘single-end capped’, or ‘double-end capped’. Examples of commercial PAG oils include, but are not limited to, ND-8 (Nippon Denso), Castrol PAG 46, Castrol PAG 100, Castrol PAG 150, Daphne Hermetic PAG PL, Daphne Hermetic PAG PR (Idemitsu), Zerol™ (Shrieve Chemical Products, Inc.), Planetelf PAG (Total). Example commercial POE oils include, but are not limited to, Emkarate POE RL 32H, Emkarate POE RL 68H, Copeland Ultra 22CC, Copeland Ultra 32CC, Ze-GLES RB68 (Nippon Oil), Mobil EAL Arctic 68 or 32 (Mobil), Planetelf ACD 32 (Total), Bitzer BSE 32 (Bitzer).

In an embodiment of the present invention, the heat transfer composition comprises 10 to 50% by weight of polyol ester oil.

The heat transfer fluids of the present invention may optionally contain antioxidants, acid scavengers, stabilizers, defoaming agents, viscosity modifiers, UV dyes, surfactants, compatibilizers, anti-wear agents, wetting agents, solubilizing agents, extreme pressure aids, ordorants, desiccants, metal deactivators, and mixtures thereof.

### EXAMPLES

Thermal stability tests were performed according to ASHRAE 97-2007 standard: “Sealed glass tube method to test the chemical stability of materials for use within refrigerant systems”. The operating conditions are the following:

### Refrigerant: 2.2 g

### Lubricant: 5 g

### Temperature: 200° C.

Duration: 14 days
Volume of the glass tubes: 42 ml

In the test, a lubricant or lubricants was introduced into a 42 ml glass tube. The tube was drawn to vacuum and then a refrigerant was added. The tube was sealed and then aged at 200° C. for 14 days. After aging, various analyses are performed. The gas phase was recovered and analyzed by Gas Chromatography. The main impurities were identified by GUMS (gas chromatography-mass spectroscopy). Impurities were gathered from the refrigerant (fluorinated products) and the lubricant (no fluorine). The lubricant was analyzed for color (by spectrocolorimetry), humidity (by coulemtry), and total acid number (TAN) (by titration with methanolic KOH 0.01 N).

Thermal stability tests were performed using trans-HFO-1234ze as the refrigerant and with two lubricants: a polyalkylene glycol oil, PAG NDS (available from Nippon denso), and a polyol ester oil, POE Ze-GLES R1368 (Available from Nippon Oil). The results are shown in Table 1.

TABLE 1

| | PAG ND8 | POE Ze-GLES RB68 |
|---|---|---|
| Gas Phase by-products: | | |
| * from refrigerant | 4000 ppm | 500 ppm |
| | +6000 ppm | +1500 ppm |
| | (HFO-1234yf) | (HFO-1234yf) |
| * from the lubricant | 2% | 800 ppm |
| Lubricant Analysis: | | |
| * Color | 17 Gardner | 300 Hazen |
| * Humidity | 1100 ppm | 500 ppm |
| * TAN | >10 mg KOH/g | 0.6 mg KOH/g |

The results show that trans-1234ze is surprisingly more stable in the presence of POE oil than PAG oil as indicated by the surprisingly low concentration of impurities in the refrigerant and lubricant as well as the lower color, humidity and TAN after aging testing.

1. A heat transfer composition comprising 1,3,3,3-tetrafluoropropene and a polyol ester oil.

2. The heat transfer composition of claim 1 where the 1,3,3,3-tetrafluoropropene is the trans-isomer.

3. The heat transfer composition of claim 1 wherein the polyol ester oil comprises 10 to 50% by weight of the polyol ester oil and 1,3,3,3-tetrafluoropropene composition.

4. The heat transfer composition of claim 1 where the polylol ester oil is obtained by reacting a carboxylic acid with a polyol comprising a neopentyl backbone selected from the group consisting of neopentyl glycol, trimethylol propane, pentaerythritol, dipentaerythritol, and mixtures thereof.

5. The heat transfer composition of claim 1 where the polylol ester oil is obtained by reacting an alcohol with a carboxylic acid having 2 to 15 carbons.

6. The heat transfer composition of claim 5 where the carboxylic acid is linear or branched.
